(19) United States
(12) Patent Application Publication
(10) Pub. No.: US 2018/0136825 A1
(43) Pub. Date: May 17, 2018

(54) SYSTEM AND METHOD FOR UPDATING A SIGN-ON LOGO OF AN ELECTRONIC DEVICE

(71) Applicants: Inventec (Pudong) Technology Corporation, Shanghai (CN); INVENTEC CORPORATION, Taipei City (TW)

(72) Inventor: Chung-Hui CHEN, TAIPEI CITY (TW)

(21) Appl. No.: 15/473,591

(22) Filed: Mar. 29, 2017

(30) Foreign Application Priority Data
Nov. 14, 2016 (CN) 201610999494.8

(51) Int. Cl. G06F 3/0484; G06F 3/0482

(52) U.S. Cl. CPC G06F 3/04845; G06F 3/0482; G06F 3/04842

(57) ABSTRACT

A system for updating a sign-on logo of an electronic device includes an initialization unit, an image file determination unit, an image selection determination unit, and a logo display unit. The initialization unit is configured to initialize a hardware of the electronic device. The image file determination unit is configured to determine whether a system storage module of the electronic device stores a plurality of image files after the hardware is initialized. The image selection determination unit is configured to determine whether one of the image files is selected when the system storage module is determined storing the image files. The logo display unit is configured to display a logo image when the one of the images files is determined being selected, wherein the logo image corresponds to the one of the images files.

### RELATED APPLICATIONS

This application claims priority to Chinese Application Serial Number 201610999494.8, filed Nov. 14, 2016, which is herein incorporated by reference.

### BACKGROUND

### Technical Field

The present disclosure relates to a system and a method for updating a sign-on logo of an electronic device.

### Description of Related Art

In recent years, with the popularization of electronic devices like laptop computers and tablet computers, the technology associated with electronic devices such as software and hardware have been developed accordingly. In booting an electronic device, the electronic device generally displays a predetermined sign-on logo, such as a trademark of a manufacturing company or a customized image. However, the sign-on logo is defaulted in the electronic device before the electronic device shipping out from the manufacturing company. Therefore, when a user turns on the electronic device, the user can only see the predetermined sign-on logo, and can not easily change the sign-on logo with personal preference.

Therefore, how to provide the user with a friendly system and method for updating the sign-on logo of the electronic device, so as to freely change the sign-on logo displayed on the electronic device, has become an important research and development issue, and has been an urgent object to be improved in the related fields.

### SUMMARY

The present disclosure relates to a system and method for updating a sign-on logo of an electronic device, which may provide a user with a friendly sign-on logo updating interface for alternatively updating the sign-on logo when the electronic device is turned on.

In accordance with some embodiments of the present disclosure, a system for updating a sign-on logo of an electronic device includes an initialization unit, an image file determination unit, an image selection determination unit, and a logo display unit. The initialization unit is configured to initialize a hardware of the electronic device. The image file determination unit is configured to determine whether a system storage module of the electronic device stores a plurality of image files after the hardware is initialized. The image selection determination unit is configured to determine whether one of the image files is selected when the system storage module is determined storing the image files. The logo display unit is configured to display a logo image when the one of the images files is determined being selected, wherein the logo image corresponds to the one of the images files.

In accordance with some embodiments of the present disclosure, a method for updating a sign-on logo of an electronic device includes following steps. Initializing a hardware of the electronic device. Determining whether a system storage module of the electronic device stores a plurality of image files. Determining whether one of the image files stored in the system storage module is selected when the system storage module storing the image files is determined. Displaying a logo image corresponding to the selected image file when one of the image files is determined being selected.

In one or more embodiments of this disclosure, when the electronic device is turned on, but before entering an operating system of the electronic device, the image determination unit and the image selection determination unit may determine whether the user selects to change the sign-on logo. Then, the logo display unit may display a customized logo image or display a predetermined logo image on the display module depending on the user's selection. Therefore, by the sign-on logo updating system, the user may freely select whether to change the sign-on logo without returning the electronic device to a manufacturing company for changing settings, so as to benefit the user to freely change the sign-on logo.

It is to be understood that both the foregoing general description and the following detailed description are by examples, and are intended to provide further explanation of the invention as claimed.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a schematic diagram of a system for updating a sign-on logo of an electronic device in accordance with some embodiments of the present disclosure.

FIG. 2 is a flow chart of a method for updating a sign-on logo of an electronic device in accordance with some embodiments of the present disclosure.

FIG. 3 is a flow chart of step S30 in FIG. 2 of the method for updating a sign-on logo of an electronic device in accordance with some embodiments of the present disclosure.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

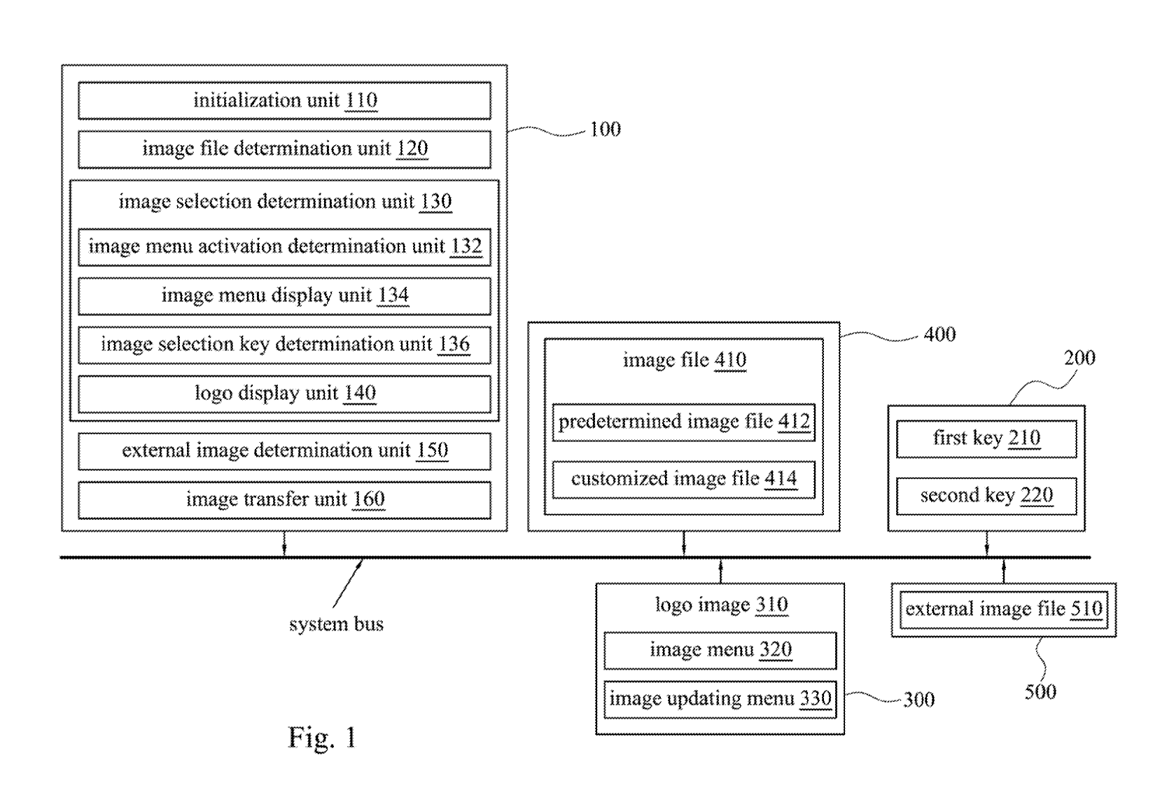

Reference is made to FIG. 1. FIG. 1 is a schematic diagram of a system for updating a sign-on logo of an electronic device in accordance with some embodiments of the present disclosure. An electronic device 10 includes a sign-on logo updating system 100, an input module 200, a display module 300, a system storage module 400 and an external storage module 500. The sign-on logo updating system 100, the input module 200, the display module 300, the system storage module 400 and the external storage module 500 may be signally connected to each other via a system bus, and a user may communicate with the sign-on logo updating system 100 and the display module 300 via the input module 200.

As shown in FIG. 1, the sign-on logo updating system 100 includes an initialization unit 110, an image file determination unit 120, an image selection determination unit 130, and a logo display unit 140. The initialization unit 110 is configured to initialize a hardware (including the input module 200) of the electronic device 10, such as a keyboard, a disk device, an input/output port, etc., to ensure the hardware of the electronic device 10 operates normally. The image file determination unit 120 is configured to determine whether the system storage module 400 stores a plurality of image files 410 after the hardware is initialized. The image selection determination unit 130 is configured to determine whether one of the image files 410 is selected when the system storage module 400 is determined storing the image files 410. The logo display unit 140 is configured display a logo image 310 when the one of the image files 410 is determined being selected, and the logo image 310 corresponds to the selected one of the image files 410.

As a result, when the electronic device 10 is turned on, but before entering an operating system of the electronic device 10, the image determination unit 120 and the image selection determination unit 130 may determine whether the user selects to change the sign-on logo. Then, the logo display unit 140 may display a customized logo image 310 or display a predetermined logo image 310 on the display module 300 depending on the user's selection. Therefore, by the sign-on logo updating system 100, the user may freely select whether to change the sign-on logo without returning the electronic device 10 to a manufacturing company for changing settings, so as to benefit the user to freely change the sign-on logo.

More particularly, after the electronic device 10 is turned on, the initialization unit 110 may execute functions of hardware initialization, hardware detection and etc. Then, the image determination unit 120 may determine whether the system storage module 400 stores a plurality of image files 410. In other words, determine whether the system storage module 400 has a predetermined image file 412 and a customized image file 414. When the system storage module 400 is determined not to store the image files 410, that is, the system storage module 400 only has the predetermined image file 412; the image selection determination unit 130 may not execute the function of determination. However, the logo display unit 140 may display the predetermined logo image 310 on the display module 300 of the electronic device 10, and the predetermined logo image 310 corresponds to the predetermined image file 412 stored in the system storage module.

In some embodiments, the electronic device may be, but not limited to be, a laptop computer or a tablet computer. In some embodiments, the system storage module 400 may be, but not limited to be, a read only memory (ROM), such as a programmable read only memory, or a flash read only memory.

In some embodiments, the initialization unit 110, the image file determination unit 120, the image selection determination unit 130, and the logo display unit 140 may be integrated into one or more processing devices of the electronic device 10. The processing device may be, but not limited to be, a central processing unit, a controller, a microprocessor, a sever, or any other hardware can process instructions.

In other embodiments, the initialization unit 110, the image file determination unit 120, the image selection determination unit 130, and the logo display unit 140 may be executed by a computer program of an electronic device and be stored in a storage device. The storage device may include a non-transient computer readable recording medium or other device having a storage function. The computer program may include, but not limited to, a plurality of program instructions which can be executed by a central processing unit, so as to execute the respective functions of the modules.

In some embodiments, for example, the initialization unit 110, the image file determination unit 120, the image selection determination unit 130, and the logo display unit 140 may be executed by a basic input/output system (BIOS) of the electronic device 10. After the electronic device 10 is turned on, the basic input/output system may be decompressed to a main memory of the electronic device 10, and then the basic input/output system may execute a power on self-test (POST) and a bootstrap program. The bootstrap program is configured to load the operating system from the storage device into the main system to activate the operating system and complete a boot process. Furthermore, the basic input/output system further provides the operating system and an application program with functions of interrupting a terminate and stay resident program and recording setting values of system, which are well known to those skilled in the art and will not be described in detail herein.

In some embodiments, the image selection unit 130 further includes an image menu activation determination unit 132, an image menu display unit 134 and an image selection key determination unit 136. The image menu activation determination unit 132 is configured to determine whether a first key 210 of the electronic device 10 pressed is an image menu activation key when the system storage module 400 is determined storing the image files. The image menu display unit 134 is configured to display a system interface when the first key 210 is determined being the image menu activation key, and the system interface includes an image menu 320 corresponding to the image files 410 stored in the system storage module 400. The image selection key determination unit 136 is configured to determine whether a second key 220 of the electronic device 10 pressed is one of a plurality of image selection keys, and the image selection key corresponds to the image menu 230. When the second key 220 is determined being one of the image selection keys, the image selection unit 130 may determine the image file 410 being selected.

In other words, in some embodiments, when the system storage module 400 is determined storing the predetermined image file 412 and at least one customized image file 414, if the user press the first key 210, and the first key 210 is determined being the image menu activation key by the image menu activation determination unit 132, the system interface may be activated. Then, the image menu display unit 134 may display the image menu 320 on the system interface. In other words, the user may watch a system setting image (that is, the system interface). Then, if the user press the second key 220, and the second key 220 is one of the image selection keys, the image selection key determination unit 136 may determine the second key 220 being the image selection key and generate an image selection signal. Therefore, the image selection unit 130 may determine the image file 410 being selected.

In some embodiments, for example, the image menu 320 may provide the user with one or more available-press image selection keys and the corresponding information of the image files 410. In some embodiments, for example, the image menu 320 may include a plurality of images, and each of the images may display a pattern of the corresponding image selection key and the corresponding logo image 310 after the image selection key is pressed, but it is not limited thereto.

In some embodiments, the input module 200 may be, but not limited to be, a keyboard, such as a wireless keyboard or a wire keyboard. In some embodiments, when the input module 200 is the keyboard, the first key 210 and the second key 220 may be any key of the keyboard, and a specific key of the keyboard may be image menu activation key or the image selection key. For example, a Alt key, a Ctrl key or a Menu key may be preset as the image menu activation key, and the number keys of the keyboard, such as 1, 2, 3 . . . , 9 or the combination thereof may be preset as the image selection keys, but it is not limited thereto.

In some embodiments, at least one of the image files 410 is from the external storage module 500. In some embodiments, the external storage module 500 may be a hard disk or other computer readable medium. For example, the external storage module 500 may be, but not limited to be, a universal serial bus flash driver (USB flash drive), a solid state drive (SSD), a removable media device, a memory card, a flash memory card, As a result, due to a portability of the external storage module 500, the different users may exchange or update the contents of the image files 410 with each other by the external storage module 500, instead of returning the electronic device 10 to the manufacturing company for changing settings, so as to benefit the sign-on logo updating system 100 to provide a variety of sign-on logos.

In some embodiments, the sign-on logo updating system 100 further includes an external image determination unit 150 and an image transfer unit 160. The external image determination unit 150 is configured to whether the external storage module 500 of the electronic device 10 stores an external image file 510 after the logo display unit 140 displays the logo image 310. The image transfer unit 160 is configured to transfer the external image file 510 into one of the image files 410 stored in the system storage module 400 when the external storage module 500 is determined storing the external image file 510. For example, the external image file 510 may be, but not limited to be, a file with a specific format, such as a file with file allocation table format. In other words, after the logo image 310 is displayed on the display module 300, if the external storage module 500 stores the external image 510 with the specific format, the external image determination unit 150 may determine the external storage module 500 to have the external image file 510. Then, the image transfer unit 160 may transfer the external image file 510, that is, the image transfer unit 160 may flag the external image file 510, so the flagged external image file 510 may become the system storage module 400 readable file, such as the image file 410. As a result, by such a combination of the external storage module 500, the external image determination unit 150 and the image transfer unit 160, the user may update or increase the image files 410 without complex system setting, so as to benefit the sign-on logo updating system 100 to provide a variety of sign-on logos.

In some embodiments, when the external storage module 500 is determined storing the external image file 510, the image menu activation determination unit 132 may determine whether the pressed key of the electronic device 10 is the image menu activation key. When the external image determination unit 150 detects that the external storage module 500 has the external image file 510 and the image menu activation determination unit 132 detects that the pressed key is the image menu activation key, the image menu display unit 134 may display an image updating menu 330 on the system interface. In other words, the user may watch the image updating menu 330 on the display module 300. As a result, by the corresponding information displayed on the image updating menu 330 and the image transfer unit 160, the user may select whether or not to transfer and store the external image file 510 as the image file 410 of the system storage module 400.

In some embodiments, the image menu activation determination unit 132, the image menu display unit 134, the image selection key determination unit 136, the external image determination unit 150, and the image transfer unit 160 may be integrated into one or more processing devices of the electronic device 10. The processing device may be, but not limited to be, a central processing unit, a controller, a microprocessor, a sever, or any other hardware can process instructions. In other embodiments, the image menu activation determination unit 132, the image menu display unit 134, the image selection key determination unit 136, the external image determination unit 150, and the image transfer unit 160 may be executed by a computer program of an electronic device and be stored in a storage device, but it is not limited thereto.

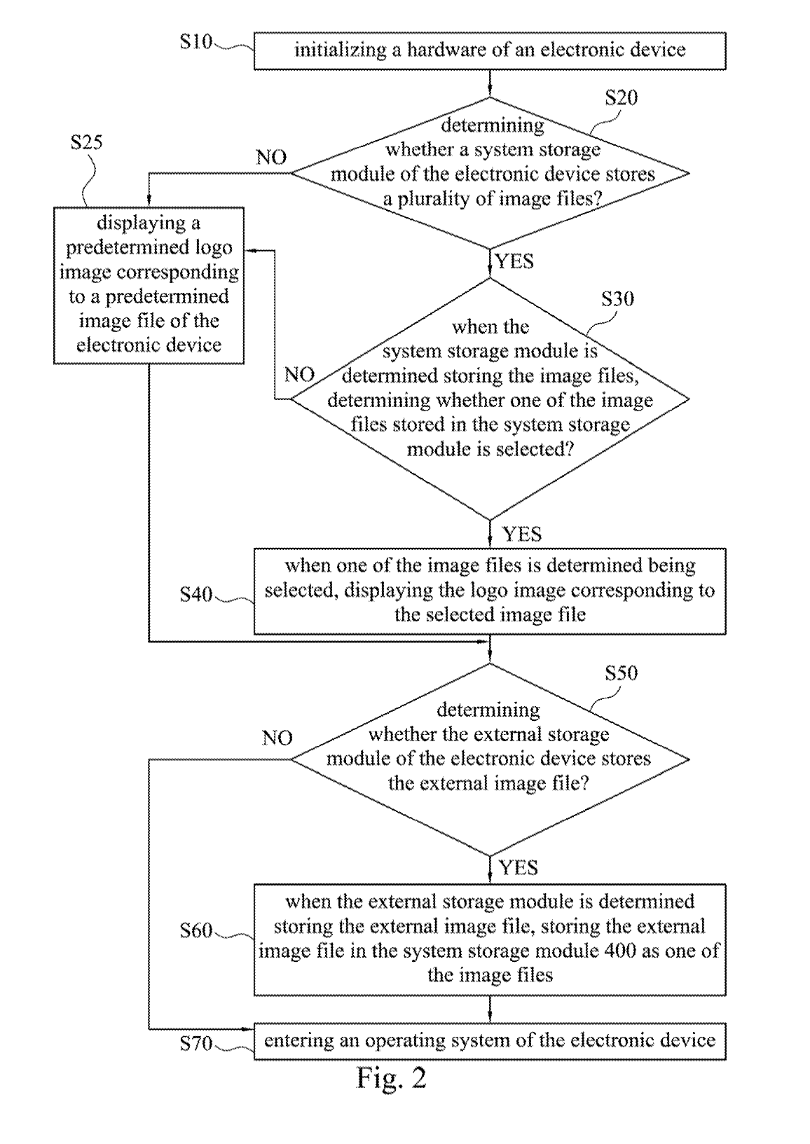

Reference is made to FIG. 2. FIG. 2 is a flow chart of a method for updating a sign-on logo of an electronic device in accordance with some embodiments of the present disclosure. In some embodiments, a method for updating a sign-on logo includes following steps. In step S10, initializing the hardware of the electronic device 10. In step S20, determining whether the system storage module 400 of the electronic device 10 stores a plurality of image files 410. If the system storage module 400 is determined storing the image files 410, that is, the system storage module 400 has the predetermined image file 412 and at least one customized image file 414, step S30 is executed; if the system storage module 400 is determined not to store the image files 410, step S25 is executed. In step S25, displaying the predetermined logo image corresponding to the predetermined image file 412 of the electronic device 10, and then step S50 is executed. In step S30, when the system storage module 400 is determined storing the image files 410, determining whether one of the image files 410 stored in the system storage module 400 is selected. If one of the image files 410 is determined being selected, step S40 is executed; if one of the image files 410 is determined not being selected, step S25 is executed. In step S40, when one of the image files 410 is determined being selected, displaying the logo image 310 corresponding to the selected image file 410. In step S50, determining whether the external storage module 500 of the electronic device 10 stores the external image file 510. If the external storage module 500 is determined storing the external image file 510, step S60 is executed; if the external storage module 500 is determined not to store the external image file 510, step S70 is executed. In step S60, when the external storage module 500 is determined storing the external image file 510, storing the external image file 510 in the system storage module 400 as one of the image files 410. In step S70, entering the operating system of the electronic device 10.

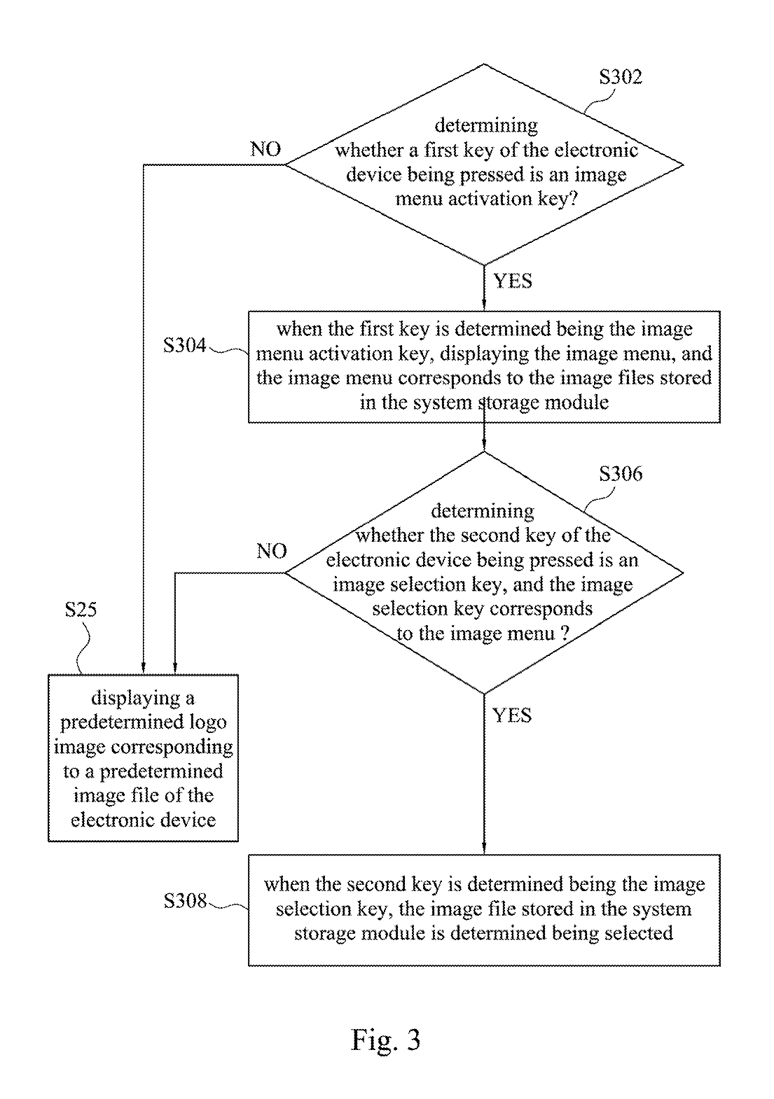

Reference is made to FIG. 3. FIG. 3 is a flow chart of step S30 in FIG. 2 of the method for updating a sign-on logo of an electronic device in accordance with some embodiments of the present disclosure. In step S302, determining whether the first key 210 of the electronic device pressed is the image menu activation key. If the first key 210 is determined being the image menu activation key, step S304 is executed; if the first key 210 is determined not being the image menu activation key or the first key 210 of the electronic device 10 is not pressed in a predetermined time, step S25 is executed. In step S304, when the first key 210 is determined being the image menu activation key, displaying the image menu 320, and the image menu 320 corresponds to the image files 410 stored in the system storage module 400. In step S306, determining whether the second key 220 of the electronic device 10 pressed is the image selection key, and the image selection key corresponds to the image menu 320. If the second key 220 is determined being the image selection key, step S308 is executed; if the second key 220 is determined not being the image selection key or the second key 220 of the electronic device 10 is not pressed in the predetermined time, step S25 is executed. In step S308, when the second key 220 is determined being the image selection key, the image file 410 stored in the system storage module 400 is determined being selected.

In one or more embodiments of this disclosure, when the electronic device is turned on, but before entering an operating system of the electronic device, the image determination unit and the image selection determination unit may determine whether the user selects to change the sign-on logo. Then, the logo display unit may display a customized logo image or display a predetermined logo image on the display module depending on the user's selection. Therefore, by the sign-on logo updating system, the user may freely select whether to change the sign-on logo without returning the electronic device to a manufacturing company for changing settings, so as to benefit the user to freely change the sign-on logo.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A method for updating a sign-on logo of an electronic device, the method comprising:
initializing a hardware of the electronic device;
determining whether a system storage module of the electronic device stores a plurality of image files;
when the system storage module storing the image files is determined, determining whether one of the image files stored in the system storage module is selected; and
when one of the image files is determined being selected, displaying a logo image corresponding to the selected image file.

2. The method for updating a sign-on logo of an electronic device of claim 1, wherein at least one of the image files is from an external storage module.

3. The method for updating a sign-on logo of an electronic device of claim 1, wherein after displaying the logo image, further comprises:
determining whether an external storage module of the electronic device stores an external image file; and
when the external storage module storing the external image file is determined, storing the external image file in the system storage module as one of the image files.

4. The method for updating a sign-on logo of an electronic device of claim 1, wherein, when the system storage module is determined not storing the image files, displaying a predetermined logo image corresponding to a predetermined image file of the electronic device.

5. The method for updating a sign-on logo of an electronic device of claim 1, wherein the determining whether the one of the image files is selected, further comprises:
determining whether a first key of the electronic device being pressed is an image menu activation key;
when the first key is determined being the image menu activation key, displaying an image menu, which corresponds to the image files stored in the system storage module;
determining whether a second key of the electronic device being pressed is an image selection key, which corresponds to the image menu; and
when the second key is determined being the image selection key, the image file stored in the system storage module is determined being selected.

6. A system for updating a sign-on logo of an electronic device, the system comprising:
an initialization unit configured to initialize a hardware of the electronic device;
an image file determination unit configured to determine whether a system storage module of the electronic device stores a plurality of image files after the hardware is initialized;
an image selection determination unit configured to determine whether one of the image files is selected when the system storage module is determined storing the image files; and
a logo display unit configured to display a logo image when the one of the images files is determined being selected, wherein the logo image corresponds to the one of the images files.

7. The system for updating a sign-on logo of an electronic device of claim 6, wherein at least one of the image files is from an external storage module.

8. The system for updating a sign-on logo of an electronic device of claim 6, further comprising:
an external image determination unit configured to determine whether an external storage module of the electronic device stores an external image file after the logo display unit displays the logo image; and
an image transfer unit configured to transfer the external image file into one of the image files stored in the system storage module when the external storage module is determined storing the external image file.

9. The system for updating a sign-on logo of an electronic device of claim 6, wherein, when the system storage module is determined not storing the image files, the display unit displays a predetermined logo image corresponding to a predetermined image file of the electronic device.

10. The system for updating a sign-on logo of an electronic device of claim 6, wherein the image selection determination unit further comprises:
an image menu activation determination unit configured to determine whether a first key of the electronic device that is pressed is an image menu activation key;
an image menu display unit configured to display an image menu when the first key is determined being the image menu activation key, which corresponds to the image files stored in the system storage module; and
an image selection key determination unit configured to determine whether a second key of the electronic device pressed is an image selection key, which corresponds to the image menu;
wherein, when the image selection key determination unit determines the second key being the image selection key, the image selection determination unit determines the image file stored in the system storage module being selected.
